(19) United States
(12) Patent Application Publication
(10) Pub. No.: US 2022/0335383 A1
(43) Pub. Date: Oct. 20, 2022

(54) MANAGEMENT FRAMEWORK FOR DELIVERING PRODUCTS AND SERVICES IN AN ENTERPRISE

(71) Applicant: Eyitayo Olaoluwa Koleoso, Silver Spring, MD (US)

(72) Inventor: Eyitayo Olaoluwa Koleoso, Silver Spring, MD (US)

(21) Appl. No.: 17/301,781

(22) Filed: Apr. 14, 2021

(51) Int. Cl. G06Q 10/10; G06T 11/20

(52) U.S. Cl. CPC G06Q 10/101; G06Q 10/103; G06T 11/206

(57) ABSTRACT

A management framework for delivering products and services in an enterprise.

### BACKGROUND OF THE INVENTION

The present invention relates to documenting, approving, tracking, and managing collaborative product development and, more particularly, a management framework for delivering products and services in an enterprise.

Many organizations involved in collaborative product development struggle to produce products in a structured, repeatable, and predictable manner. The problem is one of management. With agile teams, for instance teams running the ‘Agile’ methodology of software development, the focus is usually on just the day-to-day feature work. This has the effect of neglecting the long-term, strategic view of delivering products and services; specifically, short-sighted management fails to clarify and identify ingredients that will yield predictable results in the future for similarly situated products and services. The crux of this problem is that current top-down management frameworks have only one demographic in mind: management.

Change that is driven by those that will implement the change—a bottom-up paradigm—tends to promote the participant's commitment and engagement, which in turn creates the expectation is that the ingredients are repeatable, durable fixtures that can be reused for multiple releases of product in the same organization. The top-down management approach, in contrast, tends to dictate the ‘what’ and ‘how’ in an unresponsive and delayed manner. Furthermore, under top-down regimes, often the direction produced is not typically repeatable in future, similarly situated efforts.

As can be seen, there is a need for a management framework for delivering products and services in an enterprise, whereby the method that embodies the management framework assigns the tactics (e.g., planning and implementation) to the employees and the strategies (e.g., guidance and enablement) to the employers. At the end, the present invention provides a practical implementation of management steps that transforms an enterprise's management framework into a nimble, decentralized innovative decision-making process that encourages employee engagement and encourage employer listening in an assembly-line approach to delivering features, products, and services.

The present invention, colloquially known as ‘Better Managed Development’ (BMD) inverts the employee-management relationship, having the employees do the creative thinking and most of the planning, while management maintains strategic guidance, provides resources and arbitrates disputes. BMD is a method by which leadership and employees can collaborate on a longer-term and sustainable method for delivering features, products and services repeatably into the future. It presents a structured method and process for identifying the ingredients desirable for efficient, predictable, and sustainable delivery of features, products and services.

The “bottom-up” management embodied in the present invention deliberately separates employer-management duties and employee-worker duties, fostering an environment where employees are expected to push up ideas and tactics, while management maintains strategic direction and enablement.

### SUMMARY OF THE INVENTION

In one aspect of the present invention, a collaborative production management system, the system including the following: a processor; and a memory coupled to the processor, the memory including program instructions stored thereon that, upon execution by the processor, cause the system to: create a digital collaboration workspace for a plurality of participants comprising tactical and strategic participants, wherein each of the plurality of participants operates a respective device configured to access the digital collaboration workspace, the digital collaboration workspace including a tactical portion and one or more strategic portions, the tactical portion read and write accessible to each of the tactical participants of the plurality of participants and only read accessible to each of the strategic participants of the plurality of participants; the digital collaboration workspace provides a tactical whiteboarding application residing only in the tactical portion, wherein the tactical whiteboarding application is configured to render a vision board on a graphical user interface displayable by each device, wherein the vision board has a grid defined by a plurality of stages and a plurality of ingredients resulting in a plurality of task boxes; and the digital collaboration workspace provides a pod formation application residing only in the tactical portion, wherein the pod formation application is configured to assign each of the tactical participants as a function of the plurality of task boxes having a task inputted.

In another aspect of the present invention, collaborative production management system, the system including the following: a processor; and a memory coupled to the processor, the memory including program instructions stored thereon that, upon execution by the processor, cause the system to: create a digital collaboration workspace for a plurality of participants comprising tactical and strategic participants, wherein each of the plurality of participants operates a respective device configured to access the digital collaboration workspace, the digital collaboration workspace including a tactical portion and one or more strategic portions, the tactical portion read and write accessible to each of the tactical participants of the plurality of participants and only read accessible to each of the strategic participants of the plurality of participants, wherein each of the strategic portions are inaccessible to the tactical participants of the plurality of participants, wherein each of the strategic portions are read and write accessible to the strategic participants of the plurality of participants; the digital collaboration workspace provides a tactical whiteboarding application residing only in the tactical portion, wherein the tactical whiteboarding application is configured to render a vision board on a graphical user interface displayable by each device, wherein the vision board has a grid defined by a plurality of stages and a plurality of ingredients resulting in a plurality of task boxes, wherein a task is inputted into at least one of the plurality of task boxes; the digital collaboration workspace provides a pod formation application residing only in the tactical portion, wherein the pod formation application is configured to assign each of the tactical participants as a function of the plurality of task boxes having a task inputted; and the digital collaboration workspace provides a tasking application residing in the tactical portion and the strategic portion, wherein the tasking application is configured to track tactical and strategic participants as a function of each task inputted.

In yet another aspect of the present invention, a method identifying timely application of the plurality of ingredient of the system of claim 7, the method including the following: creating a plot wherein each of the plurality of stages as fixed variables on an X-axis of a X-Y graph; plotting in real time a count of tasks inputted defined per stage as dependent variables on the X-Y graph; and calculating a slope of the virtual graph, wherein a positive slope value indicates an undesirable outcome.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention;

FIG. 2 is a diagrammatical view of an exemplary embodiment of a task total diagram of the present invention, illustrating a dynamic BMD Readiness Score plot;

FIG. 3 is a schematic view of an exemplary embodiment of a vision board application of the present invention; and

FIG. 4 is a continuation of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a management framework for delivering products and services in an enterprise.

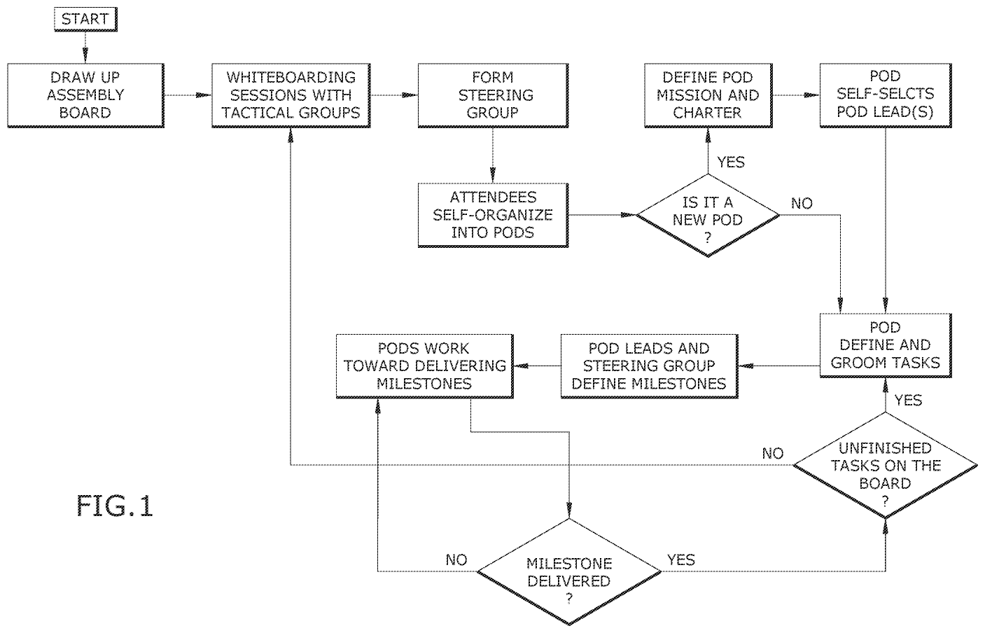

Referring now to FIGS. 1 through 4, the present invention in various embodiments may include the management framework for delivering products and services in an enterprise that is adapted to implement a number of systems and methods in the form of virtual whiteboarding applications, pod-forming applications, and tasking applications. The assets from the whiteboarding applications may be itemized as tasks in the tasking applications, wherein the itemized tasks are then split across the pods (previously formed through the podding applications).

In some embodiments, a method of the management framework may include creating a virtual collaboration workspace for a plurality of participants, wherein the plurality of participants may include tactical participants and strategical participants. Each of the participants may operate a device configured to access the workspace, the workspace including a tactical portion and a plurality of strategic portions, the tactical portion is read and write accessible to each tactical participant to the exclusion of the strategic participants' write access. Each of the plurality of strategic portions are read and write-accessible to a corresponding strategic participant to the exclusion of at least the tactical participant's read and write accessibility.

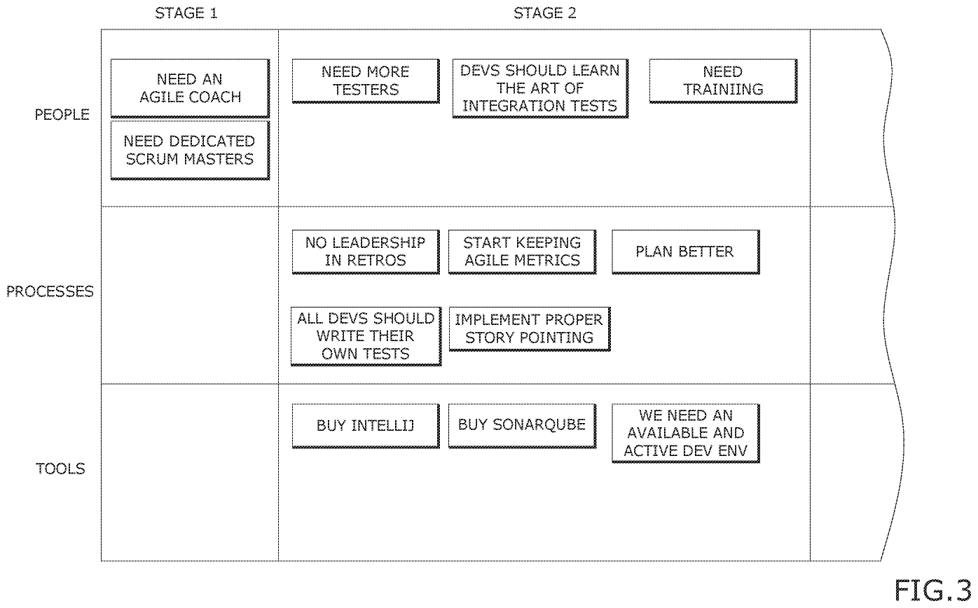

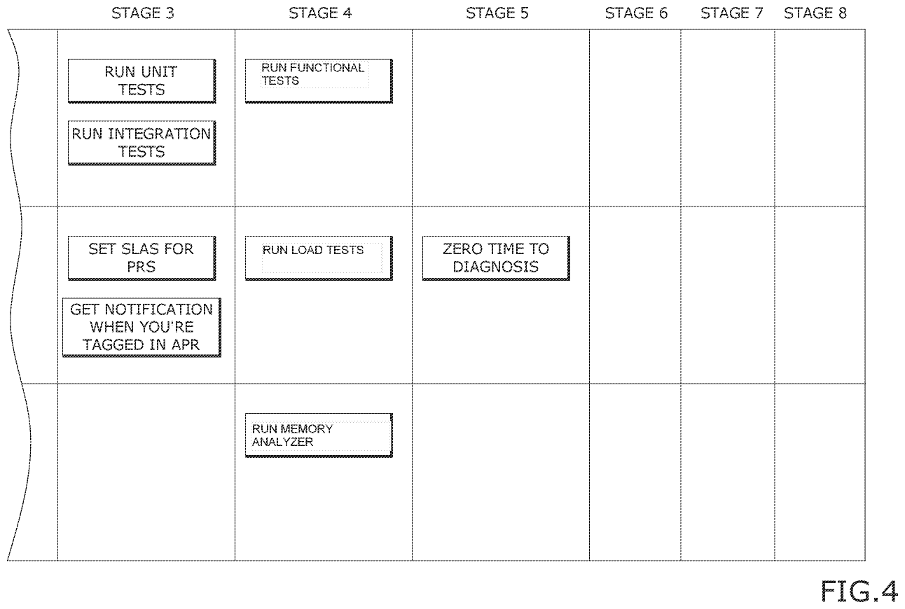

The management framework, through collaborative whiteboarding applications or sessions, enable all the tactical participants to collaboratively input data into a grid called a vision board, as illustrated in FIGS. 3 and 4. The grid may be a graphical control element that presents a tabular view of data, wherein the intersection of each column with each row defines bounded box (or “task boxes”) for inputting tasks on the part of the tactical participants. This vision board will be used to identify the people, processes, and tools necessary to deliver a desired goal through a plurality of production stages that culminate in the desired goal. Strategic participants are discouraged from participating in this vision board phase, thereby encouraging the candid and free flow of ideas from the tactical participants, conventionally defined as the “employees”, “workers”, “contractors”, “engineers”, and the like. Accordingly, in some embodiments, the whiteboarding applications, or a portion thereof, are allocated to the tactical portion of the management framework, and thus read-only accessible to the strategic participants. The strategic participants may be conventionally known as “management”, “leadership”, or the like.

The management framework shown in the Figures may be unique and linked to a specific collaboration environment (e.g., a meeting or project). These objects may be any type of binary data such as a document file (e.g., Word®, PDF), image, audio file, or text. An operatively associated storage mechanism may provide data persistence with read and write access privileges in the form of an access control list of the operatively associated storage mechanism implementation, wherein an implementation may be dictated by behavior rules, such as but not limited to the following: at block 100, the user-participant may then set the other participant's read/write privileges in the form of an access control list. For example, such an access control list may include a plurality of entries, each entry associated with a particular user and/or file, and indicating whether the user has the ability to (i) read, (ii) write, or (iii) read and write to that specific file, wherein the corresponding privilege is added for the user in the access control list.

The present invention is configured to determine whether a user-participant is authorized for write access, for example, by consulting an access control list associated with workspace content.

After whiteboarding, the tactical participants may independently form tactical “pods” within the tactical portion of the management framework. Each tactical pod tends to be groups of similarly skilled tactical participants that will handle tasks aligned with their skills.

In a software development department, for example, after a whiteboarding session, the software engineers (tactical participants) can form a “Front-End engineering (tactical) pod”, to focus solely on the whiteboarding tasks that apply to the front end. The tactical pods should have pod leads that will help coordinate the communication with other tactical pods as well as with corresponding strategic participants (management).

After forming tactical pods, each tactical pod will meet to create tasks using a ticketing system like Atlassian's JIRA. These tickets should work to produce the identified tasks from the whiteboarding phase. These tasks and their tickets should be estimated for effort. Then they will be presented to the corresponding strategic participant—who hitherto would have set strategic objectives that the identified tasks ought to align with. These tasks are then used to track the execution of the work necessary to deliver the needs identified in the whiteboarding application. The strategic objectives can optionally go on the board, inputted by the pod leads who have write-access, not the strategic participants, as they only have read-access. Though in some embodiments, one of the plurality of whiteboarding applications may include a strategic layer that can be write-accessed by the strategic participants, and overlain on the vision board by the pod leads or, in certain embodiments, the strategic participants themselves.

A critical component to the management framework is the assembly board or “vision board:” The vision board includes a grid comprising at least three (3) rows labelled “people”, “processes”, “tools” respectively. Vertically, columns are indicative different production stages the product will go through.

For a software engineering shop working on code, for example, the workspace can have “Development”, “Premerge”, “In repository”, “Post merge” etc., wherein each representing the phases/stages that code will move through for a software product to be delivered to production.

The vision board may reside in the whiteboarding application and thus in the tactical portion, and as such tactical participant populate the grid of the vision board as far as possible for each available product phase/stage, wherein those tactical participants constitute one or more associated tactical pods based on either each tactical participant's interests or skills. Not all the vertical columns of the vision board need to be filled or completed during the whiteboarding phase. The formed pods need to be aligned with aspects of the product being worked on. Pods of tactical participant then align or realign their goals with needs identified on the vision board.

Following the pod formations, each pod may create tracking tickets using task tracking tools like Atlassian's JIRA. The tickets need to describe tasks aligned (in such a way as to measure and identify the tasks' status and delivery) with the tasks described on the vision board. The tickets reside in both tactical and strategic portions and will document the level of effort for these tasks so that they can be prioritized and supported by the corresponding strategic participants.

In certain embodiments, the present invention facilitates a “Shift-Left planning and management methodology,” through computing a score that is an indication of the level of preparedness of the team for delivering the product. Using the tasks input into the vision board, a numerical score will be calculated dynamically in real time—i.e., each time the elements on the vision board are adjusted, the readiness score will be recalculated. This readiness score will then be used as an ongoing guidance mechanism for the team to work towards executing their BMD tasks earlier in the lifecycle of the product.

Specifically, after a minimum of three columns in the BMD grid of the vision board have been filled out, a computer system will have enough data to calculate the BMD Readiness Score. This score is achieved thus:

1. Take the stages defined in the BMD grid (the column titles) to be the fixed variables on an X-Y graph. This will put these stages on the X-axis of a hypothetical graph.

2. Take the number of tasks defined per stage on the BMD grid as dependent variables on an X-Y graph. This will put the count of these tasks on the Y-axis of a hypothetical graph.

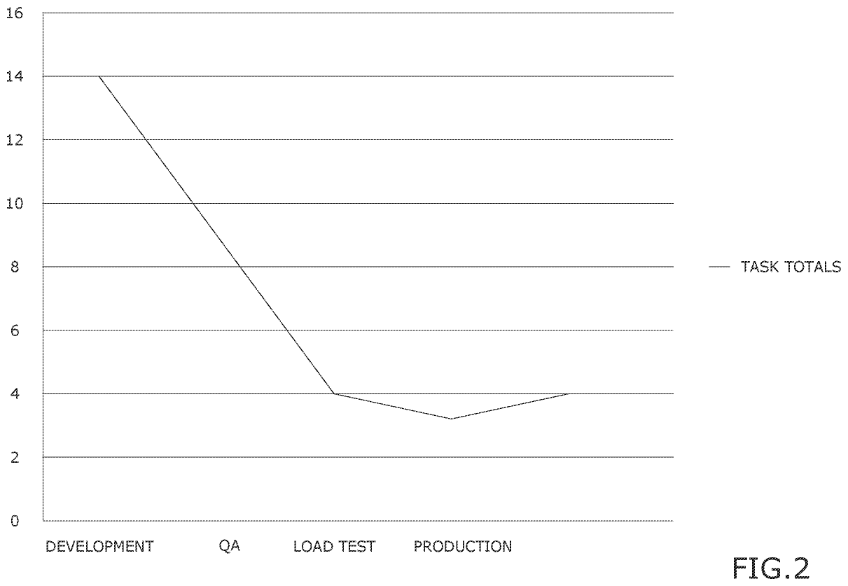

3. A computer system can then plot the number of tasks per stage on a hypothetical graph. Individual tasks on the board can be excluded from the count of eligible tasks for the computation of the readiness score, as illustrated in FIG. 2. This will help prevent unnecessary skew of tasks that are not deemed relevant to the readiness of the final product. The software system may be designed to select only relevant tasks for inclusion in the calculation of the readiness score by, for instance, marking the task for exclusion or inclusion, in the software system. Only tasks marked for inclusion will be included in the calculation of the readiness score.

a. The individual task categories or “ingredients,” i.e., people, processes and tools can be plotted individually on the graph to produce a more granular score per ingredient category or grouping.

b. The computer system may use other available metadata related to the tasks on the board to determine the representation of each task on the graph. A weight score can be assigned to an ingredient that indicates that that ingredient is of a higher significance relative to others in the same production stage of process. An example of the metadata is the level of effort; for instance, a point-based system may be adapted to account for the level of effort involved in delivering a task. Such a points-based scoring could be applied to the tasks on the board, to give them more “weight” relative to other tasks. This weight may then be reflected in the calculation to measurably affect the readiness score.

4. A computer system will then calculate the slope of the virtual graph. A positive slope value i.e., rising from left to right indicates that too much work is being done later in the cycle—an undesirable outcome; a negative slope value indicates that more work is being done earlier on in the lifecycle of the product—the desirable outcome. The computer system will display a hint or tooltip that indicates that the current state of the board is suboptimal, indicating that under the current arrangement of ingredients and tasks may indicate that too much is being done too late in the process. It will recommend a review of the vision board by some means of notification onscreen that the pod reconsider the arrangement of ingredients.

In some embodiments, for the benefit of perception by users of a computer system, the polarity of the slope value may be reversed, i.e., the positive value reversed to become negative, and the negative value being reversed to become positive. This will make for more comfortable understanding of the impact of the BMD Readiness Score, where a positive number is desirable, and a negative number is undesirable. In these embodiments, it is then preferable for users of the computer system to work toward having more tasks leftwards on the BMD grid, so that the computer system displays an increasingly positive number as fewer and fewer tasks become necessary as the BMD grid is filled rightward.

The methods of the management framework may include regular check-in meetings between pod members, regular check-in meetings between pod leadership and organizational leadership (strategic participants), and regular cadence for reviewing the vision board by leadership (strategic participants) and pod members Additionally, a new row could be added to the vision board and named something different. The rows of the grid could be renamed for different “ingredients”, for instance.

The present invention is intended for managing how a product is delivered, and not for delivering of the product itself. For an accounting software shop for example: when they are about to deliver a new software product, a BMD workgroup may be formed comprising the tactical participants that will directly work on the software product. Senior strategic participants may set specific, identifiable, and measurable strategic goals that they need the BMD group to focus on. The tactical participants working on the project will gather and have a whiteboarding session, identifying the people (tactical participants), processes and tools necessary for delivering the latest version of their accounting software. The tactical participants will need to identify these dimensions for every identifiable phase that their code will traverse. After the whiteboarding exercise, the tactical participants can then form pods that will focus on specific tiers of the accounting software. In the pods, during the tasking application, they will create tickets and estimate their level of effort per ticket. These tickets will then be brought forward by the pod leads to corresponding strategic participants. A negotiation follows on the prioritization of the identified tasks for the short and medium term. Once approved by the corresponding strategic participants, the pods will set to work to deliver those tasks in a timely manner. Clear milestones should be defined in working through the ticketed tasks.

The configurable present invention can also facilitate the grooming leaders, improving speed of delivering a product, and improving employee satisfaction and engagement.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

The operatively associated storage mechanism may provide data persistence with read and write access privileges in the form of an access control list, wherein an implementation may include, for example, a Storage Area Network (SAN), a network-attached storage device, a distributed database or cache, or the like. Other implementations may include external repositories or a cloud service. Behavior rules may dictate what is being dragged, where it is dropped, and the appropriate authorization privileges (read/write) to apply for sharing content across users or participants. As such, the systems and methods described above enable dynamic moderation control of in-session content, in contrast to asynchronous files sharing.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example, and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A collaborative production management system, the system comprising:
a processor; and
a memory coupled to the processor, the memory including program instructions stored thereon that, upon execution by the processor, cause the system to:
create a digital collaboration workspace for a plurality of participants comprising tactical and strategic participants, wherein each of the plurality of participants operates a respective device configured to access the digital collaboration workspace, the digital collaboration workspace including a tactical portion and one or more strategic portions, the tactical portion read and write accessible to each of the tactical participants of the plurality of participants and only read accessible to each of the strategic participants of the plurality of participants;
the digital collaboration workspace provides a tactical whiteboarding application residing only in the tactical portion, wherein the tactical whiteboarding application is configured to render a vision board on a graphical user interface displayable by each device, wherein the vision board has a grid defined by a plurality of stages and a plurality of ingredients resulting in a plurality of task boxes; and
the digital collaboration workspace provides a pod formation application residing only in the tactical portion, wherein the pod formation application is configured to assign each of the tactical participants as a function of the plurality of task boxes having a task inputted.

2. The system of claim 1, wherein each of the strategic portions are inaccessible to the tactical participants of the plurality of participants.

3. The system of claim 1, wherein each of the strategic portions are read and write accessible to the strategic participants of the plurality of participants.

4. The system of claim 1, wherein a task is inputted into at least one of the plurality of task boxes.

5. The system of claim 4, wherein the digital collaboration workspace provides a tasking application residing in the tactical portion and the strategic portion, wherein the tasking application is configured to track tactical and strategic participants as a function of each task inputted.

6. The system of claim 1, wherein the plurality of ingredients comprises at least three rows labelled “people”, “processes”, and “tools”.

7. A collaborative production management system, the system comprising:
a processor; and
a memory coupled to the processor, the memory including program instructions stored thereon that, upon execution by the processor, cause the system to:
create a digital collaboration workspace for a plurality of participants comprising tactical and strategic participants, wherein each of the plurality of participants operates a respective device configured to access the digital collaboration workspace, the digital collaboration workspace including a tactical portion and one or more strategic portions, the tactical portion read and write accessible to each of the tactical participants of the plurality of participants and only read accessible to each of the strategic participants of the plurality of participants, wherein each of the strategic portions are inaccessible to the tactical participants of the plurality of participants, wherein each of the strategic portions are read and write accessible to the strategic participants of the plurality of participants;
the digital collaboration workspace provides a tactical whiteboarding application residing only in the tactical portion, wherein the tactical whiteboarding application is configured to render a vision board on a graphical user interface displayable by each device, wherein the vision board has a grid defined by a plurality of stages and a plurality of ingredients resulting in a plurality of task boxes, wherein a task is inputted into at least one of the plurality of task boxes;
the digital collaboration workspace provides a pod formation application residing only in the tactical portion, wherein the pod formation application is configured to assign each of the tactical participants as a function of the plurality of task boxes having a task inputted; and
the digital collaboration workspace provides a tasking application residing in the tactical portion and the strategic portion, wherein the tasking application is configured to track tactical and strategic participants as a function of each task inputted.

8. A method identifying timely application of the plurality of ingredient of the system of claim 7, the method comprising:
creating a plot wherein each of the plurality of stages as fixed variables on an X-axis of a X-Y graph;
plotting in real time a count of tasks inputted defined per stage as dependent variables on the X-Y graph; and
calculating a slope of the virtual graph, wherein a positive slope value indicates an undesirable outcome.
